(19) United States
(12) Patent Application Publication
(10) Pub. No.: US 2019/0163691 A1
(43) Pub. Date: May 30, 2019

(54) Intent Based Dynamic Generation of Personalized Content from Dynamic Sources

(71) Applicant: CrowdCare Corporation, Richmond Hill (CA)

(72) Inventors: Jeffrey Brunet, Aurora (CA); Yousuf Chowdhary, King City (CA); Karthik Balakrishnan, Etobicoke (CA); Karen Chan, Richmond Hill (CA); Ian Collins, Markham (CA)

(73) Assignee: CrowdCare Corporation

(21) Appl. No.: 16/203,756

(22) Filed: Nov. 29, 2018

Related U.S. Application Data
(60) Provisional application No. 62/592,850, filed on Nov. 30, 2017.

(51) Int. Cl. G06F 16/332; G06F 16/338; G06F 16/35; G10L 15/18; G10L 15/22

(52) U.S. Cl. CPC G06F 16/3329; G06F 16/338; G10L 2015/225; G10L 15/1822; G10L 15/22; G06F 16/35

(57) ABSTRACT

A method is provided for generating automated responses to customer questions. Terms of a customer question are received, which are then decomposed into components of the question. An intent is determined from at least one of the components. A query is formulated with the intent. The query is searched in a plurality of data sources to obtain raw search results. These raw search results are compared, and those results proximate to the intent are selected. After redundant and non-informative results are removed, these proximate search results are stored in a cache. The cache is further analyzed/processed to eliminate redundant parts. At least one of natural language understanding (NLU), natural language generation (NLG) or generative neural nets (GNN) is applied to the remaining text in the cache to generate a natural language answer to the customer question.

### FIELD OF THE INVENTION

The invention in general relates to customer care and in particular relates to generating personalized answers in response to customer questions and issues using generative neural networks.

### BACKGROUND

Searching different sources of information to find relevant information has become a norm in today's world. A person seeking information may search more than one source before getting some or all the relevant information desired. Oftentimes, a user starts by searching the internet or the intranet of a given organization looking for information. Typically, the search may yield a plurality of results that may be organized in some form of descending relevance, and the user is expected to browse more than one of these results to assemble an answer/solution for their query. In this information age there is a lot of content that is available but it is fragmented and a user is expected to piece together an answer that suits them. To compound the situation, there are many different dynamic data sources, but no one particular database or content source that can comprehensively answer all of the questions asked by the varied users all over the world. Wikipedia is one such attempt to assemble information centrally but over time it has also not only become fragmented but still remains far short of the target. Thus, when searching it is typical that a user may search the internet, internal databases (e.g. intranet at an enterprise), forums, curated answers, user groups, etc.

A user typically gathers bits of information from each of the different relevant sources and then must synthesize an answer/solution of their own. This process is prone to human error, as a user can easily miss any number of relevant and informative sources of information. Additionally, the effort done by one user to gather the information to assemble a comprehensive solution or answer is not easily usable by another user. Thus, a second and a third user go through the same process ab initio and most likely arrive at varying assemblages based on their personal biases, time and effort spent, and their skill/expertise level.

### SUMMARY OF THE INVENTION

Broadly speaking, the present invention provides a method and a system of intent based dynamic generation of personalized content from dynamic sources as a response to a user query or question.

The present system analyzes the questions asked by users for their intent in order to provide succinct information as a response. Due to the focus on intent, the information is personalized and is synthesized from a wide set of information sources in light of user behaviour and other factors relevant to the situation or timeframe.

This provides the ability to generate and serve concise and accurate summary information in response to a customer query or an issue, instead of just serving search results for a wide set of results, where a user is expected to sift and find the relevant information from the results. The present system assembles the relevant information for the user thus saving them time and effort as well as producing better results that can be used for answering the same question asked by other users.

A user asks a question on an issue or an unknown either using a browser e.g. performing a search like function or using an app installed on a mobile device to do the same.

An app may be installed on a mobile device, which is used by a customer to ask a question about a product or a service that the organization (e.g. a mobile network operator) provides to the user. In this disclosure customer questions/comments/complaints are also collectively referred to as customer questions.

Unlike prior art methods the present invention may also acquire and use contextual information from user devices e.g. mobile phone, SmartTV and the OSS/BSS to increase the accuracy of the assembled information.

A question/comment/complaint is received from a customer at the remote server. The customer may send the question/comment/complaint using an app that may be installed on a mobile device e.g. a Smartphone. In one embodiment the question asked by the user may be converted into text if the question is in non-text format, e.g. voice.

The system decomposes the question into components. In one embodiment this is done using Natural Language Processing. The system then determines the intent of the question. Intent in this context can be defined as the reason or purpose of asking the question.

Using the intent from the question asked by the user, the system searches different data sources. The data sources can be internal or external and may include but are not limited to the internet, intranets, forums, groups, knowledge sources like Wikipedia available both publicly and private etc. In one embodiment the system gathers possible potential solutions or articles with information relevant in answering the question from all or a sub-set of data sources that may be available.

The system analyzes the potential solutions gathered from the different data sources i.e. the raw search results. The system then creates a list of candidate solutions from the raw search results by choosing the relevant ones and discarding others that are not relevant. These candidate solutions are then mapped in terms of their proximity to the intent of the question.

A list can then be created from the subset of proximate candidate solutions. The system then decomposes the proximate candidate solution into parts. In one embodiment the system selects parts from the candidate solution that match the intent and are informative. In one embodiment the system eliminates parts from the candidate solution that are redundant or repetitive. In one embodiment the system stores the selected parts from the candidate solutions that match intent and are informative in a cache. The cache is finalized when all the candidate solutions in the list have been processed.

The system analyzes the finalized cache that is composed of the different constituent elements selected from the list of proximate candidate solutions. Further repetitive parts may then be eliminated from the cache. Repetitiveness may be determined by comparing the different constituent elements selected from the list of proximate candidate solutions. Then the remaining parts of the cache may be selected.

These can be used to synthesize a comprehensive answer from the remaining parts using NLU, NLG and/or GNN. In one embodiment the system displays the comprehensive answer in textual form to the user, for example as text on the screen of a device. Optionally the text may be converted into voice (through text-to-speech (TTS) conversion) and played for the user.

Devices that can benefit from the system of the invention may include but are not limited to a mobile device for example a Smartphone, a tablet, a computer, a server, network appliance, set-top box, SmartTV, embedded device, computer expansion module, personal computer, laptop, tablet computer, personal data assistant, game device, e-reader, any appliances having internet or wireless connectivity and onboard automotive devices such as navigational and entertainment systems and any kind of other computing devices.

Part of the impetus for the invention lies in the fact that there are hundreds of thousands of varied data/information sources, and it is humanly not possible to analyze all of them for relevance. For example, a sentence or a paragraph in a seemingly unrelated article may be relevant for answering a question; the remainder of the article would be irrelevant and the invention is capable of taking the relevant passage(s) and combining them with other relevant passages from other articles to synthesize a succinct answer. Thus, by machine reading the informative elements and automatically including a select set of relevant ones while discarding other non-relevant ones, better results can be achieved.

According to a first aspect of the invention, a method is provided for generating automated responses to customer questions. Terms of a customer question are received, which are then decomposed into components of the question. An intent is determined from at least one of the components. A query is formulated with the intent. The query is searched in a plurality of data sources to obtain raw search results. These raw search results are compared, and those results proximate to the intent are selected. After redundant and non-informative results are removed, these proximate search results are stored in a cache. The cache is further analyzed/processed to eliminate redundant parts. At least one of natural language understanding (NLU), natural language generation (NLG) or generative neural nets (GNN) is applied to the remaining text in the cache to generate a natural language answer to the customer question.

The answer can then be displayed to the customer, or played as a voice output (following text-to-speech conversion), or some other form of output.

The terms of the customer question may be received by typing text, or by voice input (converted to text by speech-to-text conversion), or some other form of input.

In one embodiment, the receiving step utilizes a specialized app on the device.

The terms of the customer question may be concatenated with other information gathered from the customer's device or from an account associated with the customer at the receiving step.

The intent may be determined from the information gathered from the customer's device or account.

The decomposing step preferably uses natural language processing (NLP).

Processing to remove the non-informative results preferably uses PageRank or Maximum Entropy Decision Tree algorithms.

The query may include a non-intent component from the customer question and the intent, for example, in a concatenated string.

The intent is preferably determined using an intent classifier. This intent classifier may be a module or algorithm within an artificial intelligence engine.

The intent may be in a tag format.

### BRIEF DESCRIPTION OF THE FIGURES

FIG. 1 is a flow diagram illustrating a first part of a basic process for dynamic generation of personalized content from dynamic sources.

FIG. 2 is a flow diagram illustrating a second part of the basic process.

FIG. 3 is a conceptual diagram of an exemplary set of candidate solutions analyzed for their proximity to the intent.

FIG. 4 is a flow diagram illustrating a third part of the basic process.

FIG. 5 is a flow diagram illustrating a fourth part of the basic process.

FIG. 6 is a flow diagram illustrating a fifth part of the basic process.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in details, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a mobile device or partly on the mobile device as a stand-alone software package; partly on the mobile device and partly on a remote computer or remote computing device or entirely on the remote computer or server or computing device. In the latter scenario, the remote computer may be connected to the mobile device through any type of network, including a local area network (LAN) or a wide area network (WAN), or the connection may be made to the internet through a mobile operator network (e.g. a cellular network).

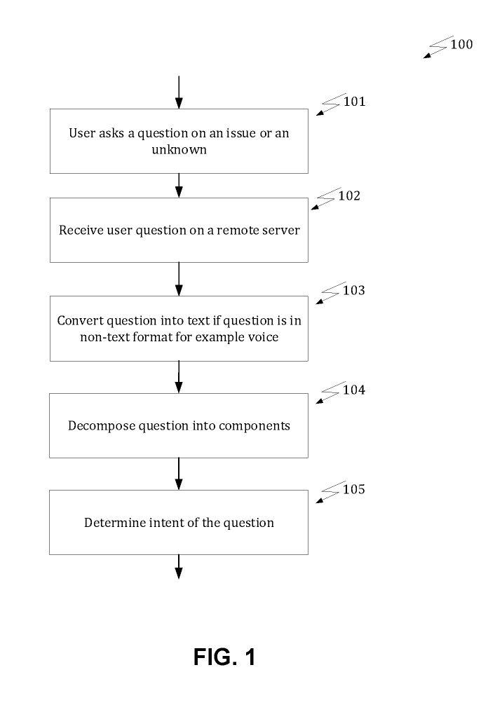

A system and method is provided of intent based dynamic generation of personalized answers (content) from dynamic sources. FIG. 1 shows a first part of the method.

A user/customer asks a question on an issue or an unknown 101. A customer may ask a question either using a browser e.g. performing a search like function or using an app on a mobile device to do the same. An app installed on a mobile device may be used by the customer to ask a question about a product or a service that the organization (e.g. a mobile network operator) is providing to the user. In this disclosure customer questions/comments/complaints are also collectively referred to as customer question.

The system may also acquire and use contextual information from the user devices e.g. mobile phone, SmartTV and the OSS/BSS to increase the accuracy of the assembled information.

A question is received at the remote server 102. The customer may send the question/comment/complaint using an app that may be installed on a mobile device e.g. a Smartphone. The remote server may be accessible over a network e.g. Internet or LAN (Local Area Network). In one embodiment a server may be a standalone computer that is connected to the internet or other network while in other embodiments it may refer to a set of networked computing devices.

In certain embodiments the search/querying functionality may be embedded in an app or software application that is installed on a device. In one embodiment the app of invention may be downloaded from an AppStore.

In one embodiment device information may be gathered and acquired from the mobile device to supplement the question posed by the customer/user. Information that can be gathered from the device may include but is not limited to: the device make, model and manufacture information, OS and firmware versions; applications (commonly referred to as “apps”) installed on the device; apps and processes running on the device; certificates on the device; user profile information; the character of any passcode used to authenticate a user (e.g. whether a password/passcode is used and the relative strength of that password, such as the number of characters); information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user, stored WiFi networks, devices paired with a Bluetooth connection, etc.

The system may gather and send this device information at the same time as the customer asks the question. Alternatively, the device information can be gathered and sent on demand at a later time.

In one embodiment, the app, in addition to the device information e.g. device make, model, OS and firmware versions etc., may extract other information from the device, such as the error logs, types of errors, number of errors, severity of errors, number and frequency of crashes of the device, etc.

The system converts the question into text if the question is in non-text format (e.g. voice) 103.

The customer's question may be received in a text format by typing or using a touch screen interface on a mobile device like a Smartphone or a tablet. In other embodiments the customer may ask the question using voice (or vocal commands) and the communication may be converted to text format using Speech to Text technologies. Other embodiments may use other methods of input.

The system decomposes the question into components 104, e.g. using Natural Language Processing. Natural Language Processing (NLP) is a computational method for analyzing the language of electronic texts, interpreting their linguistic content and extracting information from them that is relevant for specific tasks. In one embodiment of the invention, the NLP system segments the question into linguistically significant units (sentences, clauses, phrases, tokens) and determines the semantic significance of these units. The semantic significance of these units is not only determined by their near and long-distance linguistic context but also by the linguistic situation in which the question has been asked.

To demonstrate the use of natural language processing here, take the following example:
“Hi. why does my phone use data when I'm on wifi? Thank you.”

This query can be split into 3 sentences. Each sentence is then “tokenized”: punctuation is separated from the words, contractions are separated into separate words. The sentences are categorized (ignorable vs not ignorable), and the key sentences are retained.

So, from the initial question, the following is retained:
“why does my phone use data when I'm on wifi?”

The words in the sentence are assigned parts of speech:
“posResults=[why_WRB does_VBZ my_PRP$ phone_NN use_VB data_NN when_WRB i_PRP 'm_VBP on_IN wifi_NN._.]”

Where the parts of speech indicate the syntactic role of the words and become input for the semantic parser:
NN=singular noun
PRP$=possessive adjective
PRP=personal pronoun
IN=preposition
VBZ=third-person singular verb
WRB=interrogative adverb

The sentence is then processed with a dependency grammar parser which groups the words into meaningful phrases and labels their semantic roles:
(TOP (SBARQ (WHADVP (WRB why)) (SQ_CAUSE (VBZ does) (SUBJECT (NFOOT (DP (PRP$ my))) (NHEAD (NN phone))) (ACTION (VHEAD (VB use))) (OBJECT (NHEAD (NN data))) (SBAR (WHADVP (WRB when)) (S (SUBJECT (NHEAD (PRP i)))(STATE (VHEAD (VBP 'm))) (IN on) (COMPLEMENT (NHEAD (NN wifi)))))) (. .)))

Thus, these semantic fields are assigned to the sentence:
ACTION: use
SUBJECT: phone
OBJECT: data
COMPLEMENT: wifi

The system then determines the intent of the question 105. Intent in this context can be defined as the reason or purpose of asking the question. Intent can also imply the state of a person's mind that has asked the question.

A piece of unstructured text can be analyzed using Natural Language Processing, the subsequent concepts are analyzed for an understanding of these words and how they relate to the intent of the question asked by the user. An intent may be defined as a reason why the user may have asked the question in the first place.

For example, the intent will be determined using some type of rule-based algorithmic system. One such system is an intent classifier that may be part of a larger AI engine.

Identifying an intent from a user's question is usually performed as a classification task. The same process is commonly referred to as “Natural Language Understanding”, a subset of the broader field “Natural Language Processing”.

Let's take an example of user message: “Help me find a Chinese restaurant in New York”. The human mind quickly infers this to be someone wanting to find a restaurant that serves Chinese cuisine.

Machines train to perform “Natural Language Understanding”, i.e. intent classification, by observing a number of examples that would show how people might ask for a restaurant, and then building a mathematical representation of the same in vector space. The below are examples of how one might train a machine for identifying a request to find a restaurant:

Training data example for intent classification:

| Utterance | Tag (intent) | Named entities |
|---|---|---|
| help me find a restaurant | find_restaurant | None |
| i want to eat at an Indian | find_restaurant | restaurant_type = “Indian” |
| restaurant | | |
| help me find a chinese | find_restaurant | restaurant_type = “Chinese”, |
| restaurant in New York | | city = “New York” |

“Named entity extraction” is another sub step performed by intent classification systems in the process of natural language understanding. NLU systems explicitly train for named entity extraction, as part of the broader intent classification process. Named entities help refine the intent further, by extracting parameters from the original query. This way, the system can exhibit greater cognisance of the ask and thereby return more targeted and pin-pointed answers. For example, when the user asks “Help me find a Chinese restaurant in New York”, the system now understands that the user intent is “find_restaurant”, and the query parameters are “restaurant type=‘Chinese’, city=‘New York’”.

Now the system can find restaurants that only serve Chinese food and are based in New York, rather than searching the entire database for restaurants.

Machine Learning for intent classification may involve statistical approaches, deep learning approaches or a combination of both. One approach may involve using a Maximum Entropy model or a Naive Bayesian model for intent classification as well as named entity extraction. Another approach may involve using a TextCNN, i.e. a deep learning based approach for intent classification and a Hidden Markov Model for named entity extraction. In yet another approach, the user's question may be denoised by chunking the question into “noise” and “information” using sentence chunking or sentence detection models and then intent classification may process only the part of the sentence tagged as “information”, using a combination of techniques mentioned above.

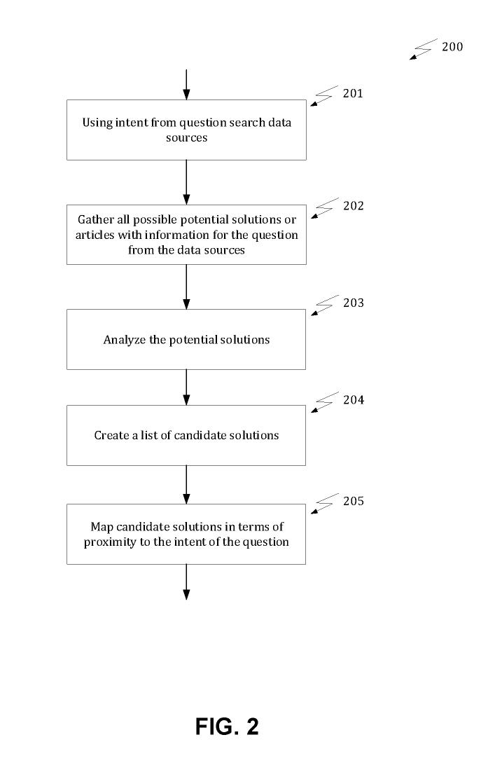

FIG. 2 shows a second part of the method 200.

Using the intent determined from the question, the system searches multiple data sources 201. The data sources can be internal or external and may include but are not limited to the internet, intranets, forums, groups, knowledge sources like Wikipedia available both publicly and privately etc. The intent is to cover all possible sources of information that may be relevant and used for given situations. Thus, what sources of information are searched may also vary from situation to situation.

The system gathers possible solutions or articles with information related to the question from the data sources 202.

The system analyzes the potential solutions 203 gathered from the different data sources e.g. the raw search results.

The system creates a list of candidate solutions 204 from the raw search results by choosing the relevant ones and discarding others that are not relevant.

Candidate solutions are mapped in terms of their proximity to the intent of the question 205.

In one embodiment machine learning may be used for mapping the candidate solutions in terms of their proximity to the intent of the question.

Prior art processes typically do not make use of any metadata or information about the extralinguistic situation in which an utterance is made. Prior art methods typically involve a “context-free” or “very near context” interpretation of the question or query. Typically, only the very near linguistic context is used to interpret the meaning of question.

In the present system, this linguistic analysis is done by an NLP system. A key part of this process is the linguistic identification of the various events that may be referred to in the user question.

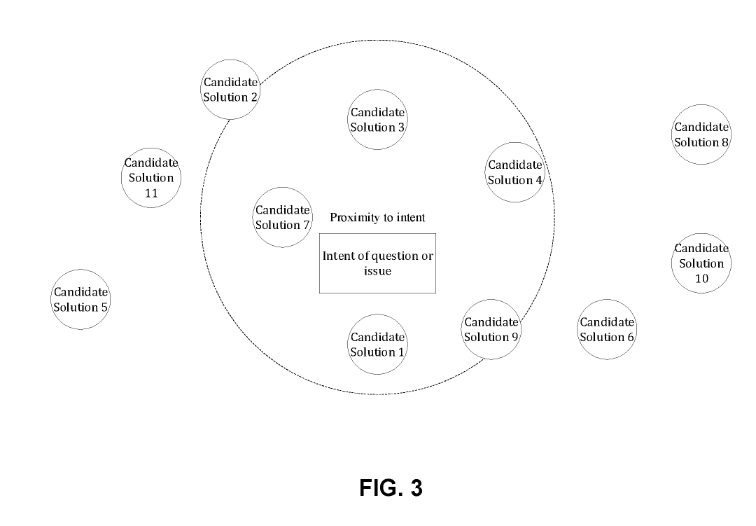

FIG. 3 shows a conceptual diagram of an exemplary set of candidate solutions analyzed for their proximity to the intent 300. The different candidate solutions are depicted mapped according to their proximity to the intent of the question asked by the user.

Proximity may be determined by choosing the candidate solution that is the best match, i.e. exhibits the highest probability among all the candidate solutions. The proximity may be inferred by using deep learning techniques, such as encoders, that operate in a high dimensional vector space. Each candidate solution may be mapped to a high dimensional vector space and the vector representation of each solution may be compared with the user's intent using distance comparison techniques such as cosine similarity or euclidean distance. In another approach, deep learning may be used to probabilistically determine proximity, with the most likely solution having the highest probability.

In the example illustrated in FIG. 3, candidate solutions 2, 5, 6, 8, 10 and 11 can be considered too distant from the intent, as they are outside the threshold that defines the outer limits of the proximity to the intent.

By contrast, candidate solutions 1, 3, 4, 7 and 9 can be considered proximate to the intent as they are inside the threshold that defines the outer limits of the proximity to the intent. Therefore, candidate solutions 1, 3, 4, 7 and 9 will be considered while candidate solutions 2, 5, 6, 8, 10 and 11 can be discarded.

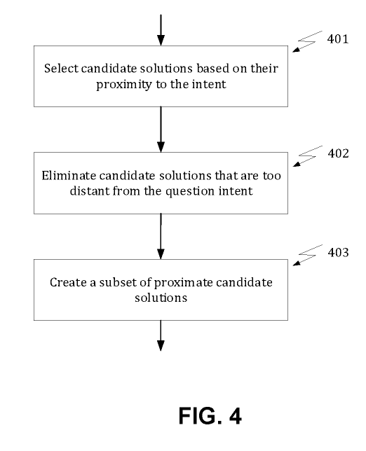

FIG. 4 shows a third part of the method 400.

The system selects candidate solutions based on their proximity to the intent 401. Referring to FIG. 3, candidate solutions 1, 3, 4, 7 and 9 will be selected.

The system eliminates candidate solutions that are too distant from the question intent 402. Referring to FIG. 3, candidate solutions 2, 5, 6, 8, 10 and 11 will be eliminated.

The system creates a subset of proximate candidate solutions 403. Referring to FIG. 3, candidate solutions 1, 3, 4, 7 and 9 will be part of the subset of the proximate candidate solutions.

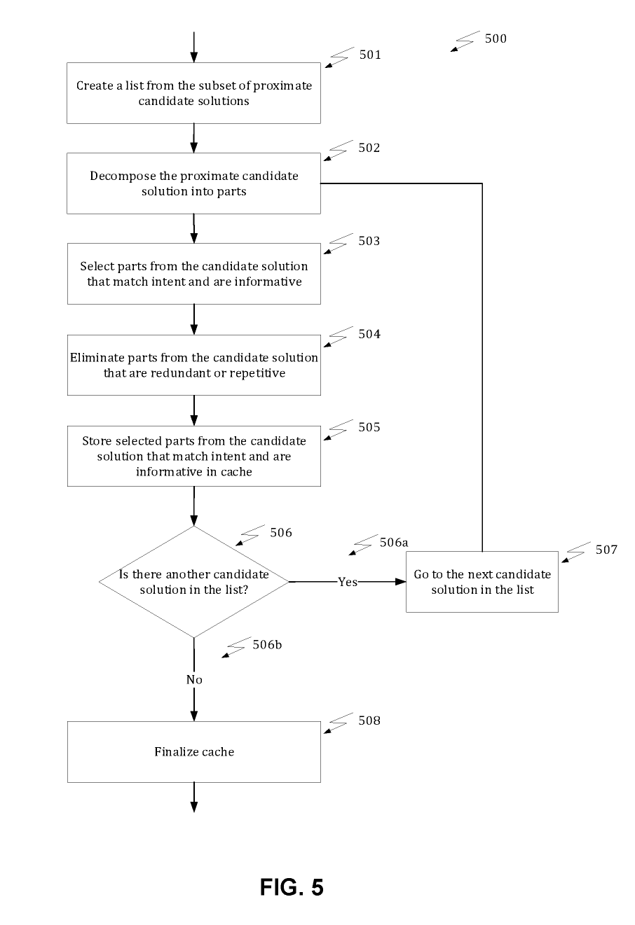

FIG. 5 shows a fourth part of the method 500.

The system creates a list from the subset of proximate candidate solutions 501.

The system decomposes the proximate candidate solution into parts 502, such as by using Natural Language Processing to decompose the proximate candidate solutions into constituent parts for further analysis.

The system selects parts from the candidate solution that match the intent and are informative 503, for example using Natural Language Processing to select parts or constituent components from the candidate solutions that match the intent of the question and are informative.

Algorithms such as PageRank may be used to determine and rank solutions (and parts of solutions) that are informative. In one embodiment, a type of Max Entropy Decision Trees may be used to determine and rank solutions (and parts of solutions) that are informative.

The system eliminates parts from the candidate solution that are redundant or repetitive 504, for example using Natural Language Processing to eliminate parts or constituent components from the candidate solutions that are redundant or repetitive by comparing the different constituent parts with each other.

The system stores selected parts from the candidate solution that match the intent and are informative in a cache 505.

The system checks whether there is another candidate solution in the list 506. If Yes 506a, there are still more candidate solutions in the list then the system goes to the next candidate solution in the list 507.

If No 506b, there are no more candidate solutions in the list, then the system finalizes the cache 508.

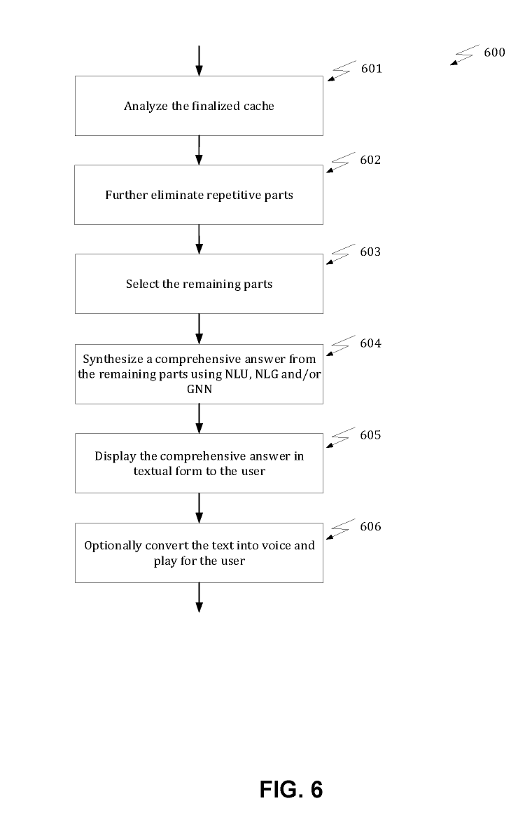

FIG. 6 shows a fifth part of the method 600.

The system analyzes the finalized cache 601 that is composed of the different constituent elements selected from the list of proximate candidate solutions.

The system further eliminates repetitive parts 602 from the cache. Repetitiveness may be determined by comparing the different constituent elements selected from the list of proximate candidate solutions.

The system selects the remaining parts 603 of the cache.

The system synthesizes a comprehensive answer from the remaining parts of the cache using NLU, NLG and/or GNN 604.

Natural Language Understanding (NLU) is a subtopic in Natural Language Processing (NLP) which focuses on how to best handle unstructured inputs such as text (spoken or typed) and convert them into a structured form that a machine can understand and act upon. The result of NLU is a probabilistic understanding of one or more intents conveyed, given a phrase or sentence. Based on this understanding, an AI system then determines an appropriate disposition.

Natural Language Generation on the other hand, is the NLP task of synthesizing text based content that can be easily understood by humans, given an input set of data points. The goal of NLG systems is to figure out how to best communicate what a system knows. In other words, it is the reverse process of NLU.

Generative Neural Nets or Generative Adversarial Networks (GAN) is an unsupervised learning technique where given samples of data (e.g. images, sentences) an AI system can then generate data that is similar in nature. The generated data should not be discernable as having been artificially synthesized.

Using one or a combination of the above-mentioned technologies, the system may formulate a solution (answer) that best addresses the user's question.

The system displays the comprehensive answer in textual form to the user 605 for example as text on the screen of a device.

Optionally (or in the alternative), the system converts the text into voice and plays it for the user 606.

Devices that can benefit from the system of the invention may include but are not limited to a mobile device for example a Smartphone, a tablet, a computer, a server, network appliance, set-top box, SmartTV, embedded device, computer expansion module, personal computer, laptop, tablet computer, personal data assistant, game device, e-reader, any appliances having internet or wireless connectivity and onboard automotive devices such as navigational and entertainment systems. Such devices may also benefit from the fact that there are hundreds of parameters and by machine reading the data elements and automatically including a select set of relevant parameters in a search query ensures increased accuracy.

It should be understood that although the term app has been used as an example in this disclosure but in essence the term may also imply any other piece of software code where the embodiments of the invention are incorporated. The software app or application can be implemented in a standalone configuration or in combination with other software programs and is not limited to any particular operating system or programming paradigm described here.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network).

In one embodiment of the invention an NLP pipeline architecture approach may be utilized for accomplishing the different inventive aspects described herein. Since an NLP pipeline is a chain of independent modules, where the output of one module becomes the input of the module after it, it will be appreciated that an NLP pipeline is variable as the number and sequence of modules can change from one embodiment to another. The intent is to cover all such combinations and permutations of different NLP modules that may be employed to create different NLP pipelines for specific embodiments or implementations.

In another embodiment of the invention a monolithic architecture may be employed such that the functionality of different NLP modules is combined into a singular program.

Several exemplary embodiments/implementations of the invention have been included in this disclosure. There may be other methods, and the intent is to cover all such scenarios. The application is not limited to the cited examples, but the intent is to cover all such areas that may benefit from this invention. The above examples are not intended to be limiting, but are illustrative and exemplary.

What is claimed is:

1. A method of generating automated responses to customer questions, comprising:
receiving terms of a customer question;
decomposing the terms of the question into components;
from at least one of the components, determining an intent and formulating a query with the intent;
searching the query in a plurality of data sources to obtain raw search results;
comparing the raw search results and selecting those results proximate to the intent;
processing the proximate search results to remove redundant results;
processing the proximate search results to remove non-informative results;
storing the processed proximate search results in a cache;
analyzing the cache to eliminate redundant parts;
applying at least one of natural language understanding (NLU), natural language generation (NLG) or generative neural nets (GNN) to the remaining text in the cache to generate a natural language answer to the customer question.

2. The method of claim 1, further comprising displaying the answer to the customer.

3. The method of claim 1, further comprising converting the answer to voice output and playing it the customer.

4. The method of claim 1, wherein the terms of the customer question are received by typing text.

5. The method of claim 1, wherein the terms of the customer question are received by voice input.

6. The method of claim 1, wherein the receiving step utilizes a specialized app on the device.

7. The method of claim 1, wherein the terms of the customer question are concatenated with other information gathered from the customer's device or from an account associated with the customer at the receiving step.

8. The method of claim 7, wherein the intent is determined from the information gathered from the customer's device or account.

9. The method of claim 1, wherein the decomposing step uses natural language processing (NLP).

10. The method of claim 1, wherein the processing to remove non-informative results uses PageRank or Maximum Entropy Decision Tree algorithms.

11. The method of claim 1, wherein the query includes a non-intent component from the customer question and the intent.

12. The method of claim 11, wherein the non-intent component and the intent are in a concatenated string.

13. The method of claim 1, wherein the intent is determined using an intent classifier.

14. The method of claim 13, wherein the intent classifier is within an artificial intelligence engine.

15. The method of claim 1, wherein the intent is in a tag format.
